(19) United States
(12) Patent Application Publication
(10) Pub. No.: US 2014/0379161 A1
(43) Pub. Date: Dec. 25, 2014

(54) Stabilizing a Voltage Supply Network

(71) Applicant: Jens-Uwe Bußer, Neubiberg (DE)

(72) Inventor: Jens-Uwe Bußer, Neubiberg (DE)

(21) Appl. No.: 14/373,543

(22) PCT Filed: Jan. 25, 2013
(86) PCT No.: PCT/EP2013/051463

§ 371 Date: Jul. 21, 2014

(30) Foreign Application Priority Data
Jan. 31, 2012 (DE) 10 2012 201 315.6

(51) Int. Cl. G05F 1/625; G05B 15/02

(52) U.S. Cl. CPC G05F 1/625; G05B 15/02
USPC 700/298

(57) ABSTRACT

Methods and devices are provided for network stabilization in smart grid voltage supply networks. Methods for stabilizing voltage supply network include: (1) receiving a control signal by a gateway of at least one subscriber; (2) generating local control commands for turning energy consumption or energy generating devices connected to the gateway on or off by the gateway of the subscriber in dependence on the received control signal; and (3) transmitting the generated local control command via a local network to at least one energy consumption or energy generating device connected to the gateway, wherein the gateway has an effective threshold value, the local control commands for turning on or off are generated when a value transmitted with the control signal exceeds or drops below the effective threshold value, and the effective threshold value is formed from a preset threshold value and a correction parameter.

### CROSS-REFERENCE TO RELATED APPLICATIONS

The present patent document is a §371 nationalization of PCT Application Serial Number PCT/EP2013/051463, filed Jan. 25, 2013, designating the United States, which is hereby incorporated by reference, and this patent document also claims the benefit of DE 10 2012 201 315.6, filed on Jan. 31, 2012, which is also hereby incorporated by reference.

### TECHNICAL FIELD

The embodiments relate to a method and a gateway for stabilizing a voltage supply network of a distribution network operator.

### BACKGROUND

In conventional networks for the transmission and distribution of electrical energy by alternating voltage (e.g., “power supply systems”), the balance between the power fed in by the generators and the power drawn by the loads is controlled by the frequency of the alternating voltage.

On average, the frequency is 50 Hz in Europe and 60 Hz in the United States. If more power is taken from the power supply system than is fed in by the generators, the rotors in the electric generators are decelerated more severely. Due to this slowing-down, the frequency of the generated alternating voltage drops in the power supply system. If, in contrast, less power is drawn than is generated, the rotors accelerate and the system frequency will increase. In this context, the inertia of the rotating masses of the rotors acts in a stabilizing manner for the power supply system since the rotors may deliver and absorb energy by a change in their frequency of rotation (primary control).

It is thus possible to balance generation and consumption by controlling the alternating voltage in the power supply system. If the frequency drops, new generators are activated. In the case of a large drop, loads may also be switched off mandatorily (load shedding). If the frequency rises, generators are shut down or possibly other loads are added (secondary and tertiary control). In the long-term mean, the system frequency, which is also used as timing for clocks (radio alarm clock, etc.), may be kept stably between 49.990 and 50.010 Hz.

Increasingly, power from regenerative sources is also fed in to the European interconnected power system, for example, from mostly small decentralized photovoltaic plants. These plants do not have any rotating masses. Instead, the generated direct current of the photovoltaic (PV) cells is transformed into alternating current by an electronic power inverter. The alternating current is fed synchronously into the local low-voltage network. To avoid large deviations from the desired system frequency, these plants, too, are controllable in dependence on frequency. These plants are responsible for a considerable proportion of the power generated locally in certain network segments, and the feeding of which may be correlated due to locally very similar solar irradiation.

Generating plants are separated from the low-voltage network within 200 ms at system frequencies of greater than 50.2 Hz. Due to this specification, however, the risk now exists due to the great spread of photovoltaics in Europe that on sunny days, several gigawatts (GW) of power fed in will become abruptly separated from the power supply system when 50.2 Hz are reached. This separation may be a considerable hazard for the stability of the European interconnected power system.

For this reason, a temporary regulation has already been issued at short notice that provides for a reduction in the feed-in in stages. Instead of a fixed over-frequency disconnection equal for all plants at 50.2 Hz, manufacturers and installers of PV plants may use different frequencies between 50.3 and 51.5 Hz as switch-off frequencies of their plants. The different frequencies may be distributed evenly.

Additionally, plants reduce their feed-in power frequency-dependently according to a defined characteristic.

If over-frequencies occur more frequently, operators of a plant with a low turn-off frequency may be economically disadvantaged since their plants turn off earlier and more frequently and, as a result, they may sell less solar power. Operators may be tempted, therefore, to increase the turn-off frequency by manipulating the setting of their plant. If such manipulations occur cumulatively, the effectiveness of the stabilization regulation is reduced.

A further regulation is possible via the system voltage measured locally at the feed-in point, where as soon as the frequency exceeds a certain value (overvoltage), the feed-in is turned off or at least reduced.

If generators having rotating masses are displaced more and more by small decentralized plants without rotating masses in future intelligent power supply systems (smart grids), control via the system frequency will become more and more difficult. Instead, for example, an electronic control signal (price signal, generation/consumption ratio, or the like) may be used in a separate communication network to devices (personal energy agent [PEA], energy gateway, control device, etc.) for controlling the decentralized generators and also loads. Here, too, attention is paid to the fact that there will be no abrupt changes in the feed-in and consumption so that the system stability is not placed at risk.

This will happen, for example, if the control signal reaches a value that is a threshold value for many (or all) gateways in the smart grid, at which the gateways change their behavior. This may be, for example, a threshold value for a comfort level by which it is set under which conditions controllable loads (freezer, air-conditioning system, etc.) are supplied with electrical energy. For example, a comfort level is “low” when the purchase of power for controllable loads is below a price of 15 c/kWh. The comfort level may be “high” when the purchase of power for controllable loads is independent of the current price.

If this threshold value is equal for many gateways in the local smart grid, they would all switch on their local loads at the same time when the value drops below this threshold value (if comfort level “low” is switched on). Such a high increase in consumption may then easily lead to risking the system stability, similar to when a system frequency of 50.2 Hz is reached, and the associated turning-off of the PV plants.

Causes for identical threshold values of gateways may be, for example: (1) legal specifications (as in the case of PV plants); (2) identical manufacturer or even identical equipment series where the devices are preconfigured with identical threshold values; (3) setting of the threshold values by a central control station; or (4) setting of the threshold values by installer/user if it may be expected that the same values will be set frequently, such as (a) by the frequent use of rounded values (e.g., 50 instead of 49 or 51), (b) values that may be set (e.g., by key repetition), or (c) if the number of possible digits is very limited (10 instead 10.7).

### SUMMARY AND DESCRIPTION

The scope of the present invention is defined solely by the appended claims and is not affected to any degree by the statements within this summary. The present embodiments may obviate one or more of the drawbacks or limitations in the related art.

It is the object of the present embodiments to create a method and a device that provides for network stabilization in a smart grid voltage supply network.

The method for stabilizing a voltage supply network has the acts of: (1) receiving a control signal by a gateway of at least one subscriber; (2) generating local control commands for turning energy consumption or energy generating devices connected to the gateway on or off by the gateway of the subscriber in dependence on the received control signal; and (3) transmitting the generated local control command via a local network to at least one energy consumption or energy generating device connected to the gateway. In such a method, the gateway has an effective threshold value. The local control commands for turning on or off are generated when a value transmitted with the control signal exceeds or drops below the effective threshold value. The effective threshold value is formed from a preset threshold value and a correction parameter.

The control signal is transmitted, for example, by a central control unit of a distribution network operator. The control signal may also be measured locally and transmitted to the gateway or determined by a measurement by the gateway itself (voltage, frequency). Furthermore, the control signal may be created in a decentralized manner and/or distributed in a decentralized manner. In this context, the gateway reacts suitably to control signals of units occurring several times or in a decentralized manner (e.g., substation controller, local power market platforms) or also parameters measured locally (e.g., system frequency, local voltage).

The parameters set (e.g., preset threshold values) are advantageously not used directly as threshold values but effective threshold values are derived therefrom. As a result, the threshold values assume different values at different devices in the smart grid and unwanted simultaneous reacting of all control devices (gateways) in the smart grid is prevented.

According to a further embodiment, the correction parameter is a random number and the effective threshold value is formed by a multiplication of the preset threshold value by the random number. If the random number is generated randomly, an approximate equal distribution of the effective threshold values is obtained even without central coordination, for stochastic reasons. For example, a random number may be generated on the basis of internal random number start numbers (“seeds”), different for the different gateways, such as the numbers are also needed for cryptographic operations, and a probability distribution (equal distribution) constant over the desired range.

According to a further embodiment, the random number and the effective threshold value are re-determined or recalculated at predeterminable or defined time intervals. This advantageously avoids that a gateway operator is permanently disadvantaged by an unfavorable value.

According to a further embodiment, the correction parameter is a time-variable function and the effective threshold value is formed time-dependently by a combination (e.g., a multiplication), of the preset threshold value and the time-variable function. This advantageously achieves as uniform as possible a distribution of the effective threshold values both between the various gateways and for the individual gateway in the course of time.

According to a further embodiment, the duration of the period is larger in comparison with a frequency of change of the control signal. This is advantageous since the number of gateways affected is as proportional as possible to this change in the case of a change of the control signal.

According to a further embodiment, the control signal has an information item about a system voltage or a system frequency and/or an information item about a power price or a generation/consumption ratio.

The gateway for network stabilization of a voltage supply network of a distribution network operator generates, in dependence on a received control signal, local control commands for turning energy consumption and energy generating devices on or off and transmits these to the energy consumption and energy generating devices via a local network. The gateway has an effective threshold value. The local control commands for turning on or off are generated when a value transmitted with the control signal is at the effective or drops below the expected threshold value. The effective threshold value is formed from a preset threshold value and a correction parameter.

### BRIEF DESCRIPTION OF THE DRAWINGS

FIG. 1 depicts a flowchart of a possible embodiment for stabilizing a voltage supply network.

FIG. 2 depicts a representation of various example correction functions for determining an effective threshold value.

FIG. 3 depicts an example representation of a variation with time of control signal and correction functions in comparison.

### DETAILED DESCRIPTION

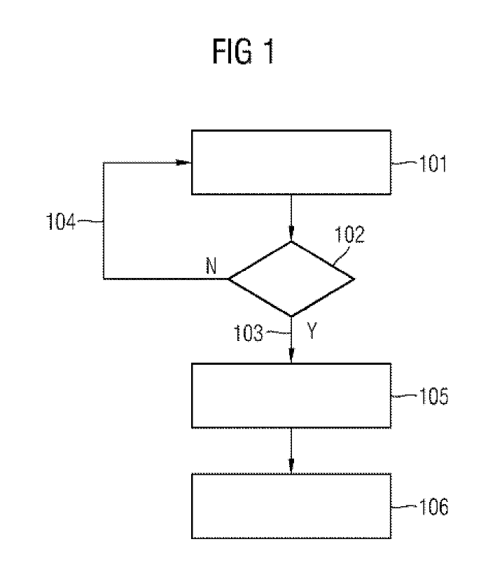

FIG. 1 depicts a flowchart of a possible embodiment of a method for stabilizing a voltage supply network of a distribution network operator.

In a first act 101, a control signal is transmitted by a central control unit of the distribution network operator to at least one gateway of a subscriber.

In a second act 102, the gateway compares a value transmitted with the control signal with a local effective threshold value.

If the effective threshold value is exceeded by the transmitted value 103, the gateway affected or addressed, respectively, generates one or more local control commands for turning the energy consumption and energy generating devices 105 connected to the gateway on or off.

As an alternative, the gateway generates one or more local control commands for turning the energy consumption and energy generating devices connected to the gateway on or off when the transmitted value drops below the effective threshold value.

If, however, the transmitted value drops below (or exceeds in the alternative embodiment) the threshold value, the gateway receives a next control signal 104 and no control commands are generated.

In a further act 106, the generated local control command is transmitted, for example, via a local power-line-based network or a local IP-based (Internet Protocol) network to the energy consumption and energy generating devices connected to the gateway.

In the text that follows, exemplary embodiments for determining the effective threshold values are described. These gateway-internal effective threshold values are intended to differ from the set threshold values. By a suitable choice of random parameters for determining the effective threshold values, it is possible to prevent the problems described above due to simultaneous turning on or off of, for example, entire classes of devices will occur (even with an identical configuration of gateways (e.g., PEAs and similar control devices)).

In certain embodiments, effective threshold values may be determined without central coordination.

### 1^{st} Variant: Constant Correction Factor

Not all gateways have the same effective threshold values, since otherwise the gateways would all react simultaneously. For this reason, during the setting of a (new) threshold value S_set and naturally during the first commissioning on taking over an initial value preset in the plant, the gateway may multiply the threshold value by a random number Z in the interval [1−P %, 1+P %]. In this context, P is dependent on the granularity of the transmitted control signal (e.g., price signal). The effective threshold value S_eff is then:

S_eff=Z*S_set, (1)

which may not be read or influenced directly from the outside in order to avoid manipulations.

If Z is generated randomly on the basis of internal random number start numbers (“seeds”), different for the different gateways, such as they are also needed for cryptographic operations, and a probability distribution (equal distribution) constant over the desired range, an approximate equal distribution of the effective threshold values is obtained even without central coordination, for stochastic reasons.

### 2^{nd} Variant: Regularly Re-established Correction Factor

The random multiplication factor is randomly recalculated time and again at particular time intervals (e.g., after some days) automatically or after request from a control center so that no gateway operator is permanently disadvantaged by an unfavorable value specified once.

As an alternative, the correction factor may also be calculated in the center and then distributed.

3^{rd} Variant: Correction Function Varying with Time

The use of a time-dependent correction function Z(t) is particularly advantageous in that the function changes the correction factor virtually continuously:

S_eff(t)=Z(t−t_{—}0)*S_set (2)

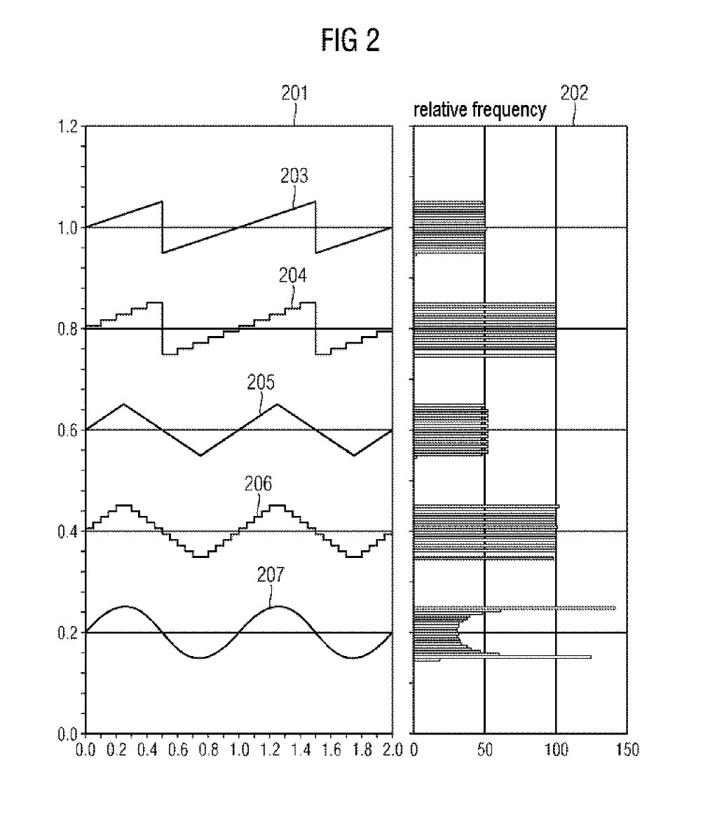

This is depicted in FIG. 2. For comparison, all functions depicted are drawn over two durations of periods: the amplitude (2P) is in each case 0.05. The frequency distribution of their values achieved as a result is depicted in the right-hand part of FIG. 2. The areas of the frequency distribution are then equal for all functions.

It is important that the frequency distributions of the assumed values 202 are as low as possible over the entire possible range of values. Due to the constant total area, a wide, constant distribution is therefore ideal.

In particular, periodic functions such as saw tooth curves 203 or zigzag curves 205 are well suited. The periodic functions or curves may be relatively smooth (e.g., steady). In such an embodiment, a distribution that is as uniform as possible and low is achieved over the entire range. In one example, the relative frequency of the values is constantly approximately 50 (arbitrary units, which depend on the “binning” or distribution of the data channels).

Compared with the saw tooth curve 203, the zigzag curve 205 also has the advantage that it avoids the unsteady jump at t=(n+0.5)*T.

Incremental functions 204, 206 are also well suited to provide sufficiently many different values, if the height of the steps is low enough. In this case, the step height was selected to be slightly too high for demonstration purposes. This selection leads to the situation that the range available for possible values is not used uniformly. This results in gaps in the frequency distribution that leads to higher frequency values of approximately 100 (arbitrary units) because of the constancy of the overall area.

Sinusoidal functions 207 are less suitable because of their non-constant frequency distribution (because, in this case, particularly large and particularly small values occur more frequently). In this case, high frequencies of almost 150 (arbitrary units) are achieved especially at the edge. However, even a sinusoidal distribution is naturally still better than the concentration on a single fixed value.

For the duration of the period of the functions used, attention is paid to the following. For one, if duration of the periods are distinctly different in different gateways, it will occur only extremely rarely in the case of sufficiently many gateways that many gateways will reach the maximum (or minimum) of their correction function at the same time.

If the gateways are time-synchronized and have identical durations of the periods of their function, a random, as uniform as possible distribution of the starting times (t_{—}0) is important. The time of the (first) commissioning alone is then not suitable as starting time because this may fall into the time 9:00 to 17:00. At least one more random equally distributed period of 0 to 24 h (better: 0 to 7*24 h) may also be added in this case.

The duration of the periods may be selected to be sufficiently long (e.g., hours or days), which may be distinctly much greater than the typical changes of the control signal in the smart grid. The duration is provided such that, in the case of a change of the control signal, the number of gateways affected is as proportional as possible to this change.

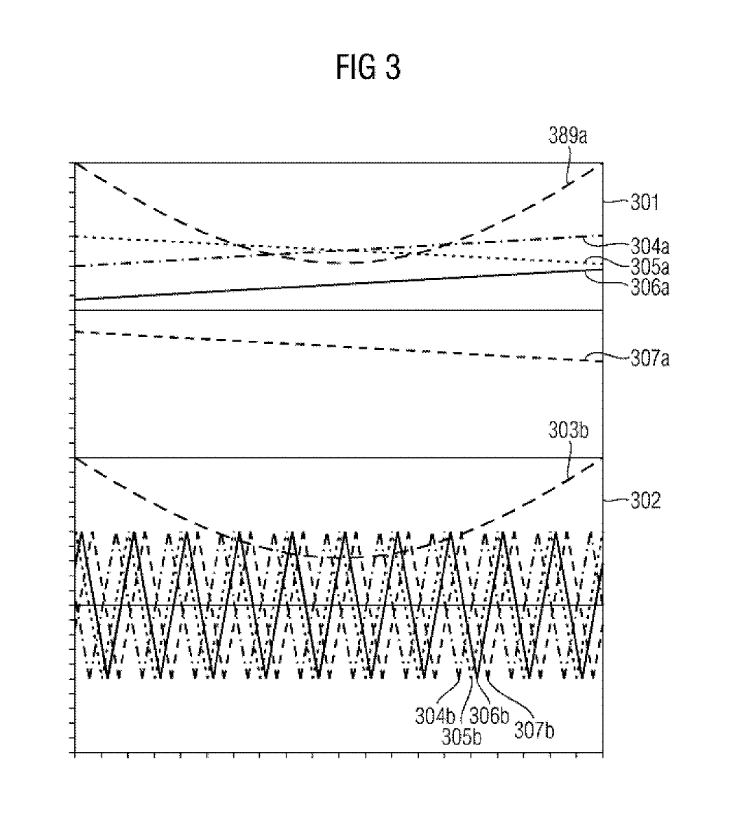

This is illustrated in FIG. 3, which depicts in two examples 301 and 302 the time variation of a control signal 303a, 303b in comparison with the time variation of the correction function Z(t) 304a-307a and 304b-307b of different gateways.

In the first example 301, the correction functions Z(t) 304a-307a vary only slowly in comparison with the control signal 303a. Depending on the intensity of the change of the control signal 303a, comparatively few gateways are activated (e.g., the two gateways 304a and 305a).

In the second example 302, the correction functions Z(t) 304b-307b vary rapidly in comparison with the control signal 303b. In this case, the threshold values of all gateways 304b-307b coincide within a short time (one duration of a period max.) with the control signal 303b and all gateways are activated—at least briefly. This coinciding within a short time may lead to a frequent turning on and off of the associated loads or generators, or, if rapid re-disconnection may not be carried out, to an activation of a large number of loads or generators, respectively. Neither is desired.

The durations of the periods (and their multiples) may not match typical rhythms (precisely one day or precisely one/eight week) in the energy network but deviate from these slightly in order to avoid that, e.g., a particular gateway always has a particularly high threshold value over a relatively long time always at noon (or every Sunday noon) and, as a result, purchases particularly expensive power.

Advantageously, it is provided that different but mutually dependent threshold values are modified suitably within a gateway. If, for example, the effective threshold value for “turning on” is reduced by 3% by the measures described above, the associated threshold value for “turning off” is corrected correspondingly in a similar manner.

In the case of continuous changes of the control signal for balancing between generation and consumption, not many gateways advantageously switch simultaneously when a threshold value is reached, but successively when reaching different threshold values over a particular bandwidth of the control signal.

If the correction factor is also varied, each gateway receives sometimes “advantageous” and sometimes “disadvantageous” threshold values. Therefore, no gateway is disadvantaged permanently by the issuing of “disadvantageous” threshold values in the temporal mean.

The network stability is increased in the smart grid, in particular, when many similar devices are used. Furthermore, the solution is compatible with a regulatory measure (similar to the temporary regulation for the PV plants at 50.2 Hz) if or as soon as such a one is decided on.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for stabilizing a voltage supply network, the method comprising:
receiving a control signal by a gateway of a subscriber;
generating local control commands for turning energy consumption or energy generating devices connected to the gateway on or off by the gateway of the subscriber in dependence on the received control signal; and
transmitting the generated local control commands via a local network to an energy consumption device connected to the gateway or an energy generating device connected to the gateway,
wherein the gateway has an effective threshold value, the effective threshold value formed from a preset threshold value and a correction parameter, and
wherein the local control commands for turning on or off are generated when a value transmitted with the control signal exceeds or drops below the effective threshold value.

2. The method as claimed in claim 1, wherein the correction parameter is a random number, and wherein the effective threshold value is formed by a combination of the preset threshold value and the random number.

3. The method as claimed in claim 2, wherein the random number and the effective threshold value are recalculated at defined time intervals.

4. The method as claimed in claim 1, wherein the correction parameter is a time-variable function, and wherein the effective threshold value is formed time-dependently by a multiplication of the preset threshold value and the time-variable function.

5. The method as claimed in claim 4, wherein the time-variable function is periodic with a duration of a period of at least an hour.

6. The method as claimed in claim 4, wherein the time-variable function is periodic with a duration of a period, wherein the duration of the period is larger in comparison with a frequency of change of the control signal.

7. The method as claimed in claim 1, wherein the control signal comprises information about a system voltage or a system frequency.

8. The method as claimed in claim 1, wherein the control signal comprises information about a power price or a generation/consumption ratio.

9. A device for network stabilization of a voltage supply network, the device comprising:
a gateway configured to:
(a) generate, in dependence on a received control signal, local control commands for turning energy consumption devices and energy generating devices on or off, and
(b) transmit the generated local control commands to the energy consumption devices and energy generating devices via a local network,
wherein the gateway has an effective threshold value, the effective threshold value formed from a preset threshold value and a correction parameter, and
wherein the local control commands for turning on or off are generated when a value transmitted with the control signal exceeds or drops below the effective threshold value.

10. The device as claimed in claim 9, wherein the correction parameter is a random number, and wherein the effective threshold value is formed by a combination of the preset threshold value and the random number.

11. The device as claimed in claim 10, wherein the random number and the effective threshold value are recalculated at defined time intervals.

12. The device as claimed in claim 9, wherein the correction parameter is a time-variable function, and wherein the effective threshold value is formed time-dependently by a multiplication of the preset threshold value and the time-variable function.

13. The device as claimed in claim 12, wherein the time-variable function is periodic with a duration of a period of at least an hour.

14. The device as claimed in claim 12, wherein the time-variable function is periodic with a duration of a period of at least a day.

15. The device as claimed in claim 12, wherein the time-variable function is periodic with a duration of a period, wherein the duration of the period is larger in comparison with a frequency of change of the control signal.

16. The device as claimed in claim 9, wherein the control signal comprises information about a system voltage or a system frequency.

17. The device as claimed in claim 9, wherein the control signal comprises information about a power price or a generation/consumption ratio.

18. The device as claimed in claim 9, wherein the control signal comprises information about (1) a system voltage or a system frequency and (2) a power price or a generation/consumption ratio.

19. The method as claimed in claim 4, wherein the time-variable function is periodic with a duration of a period of at least a day.

20. The method as claimed in claim 1, wherein the control signal comprises information about (1) a system voltage or a system frequency and (2) a power price or a generation/consumption ratio.
